(19) United States
(12) Patent Application Publication
(10) Pub. No.: US 2008/0246270 A1
(43) Pub. Date: Oct. 9, 2008

(54) Brothers XX20 Inc.

(76) Inventor: Victor L. Thompson, Manassas, VA (US)

Correspondence Address: Victor Thompson;Brothers XX20 INC., P.O. Box 1039, Woodbridge, VA, 22195, US

(21) Appl. No.: 11/512,438

(22) Filed: Apr. 2, 2007

(51) Int. Cl. B42D 15/00

(52) U.S. Cl. 283/56

(57) ABSTRACT

The included drawings are illustrations of Logos and art work created for the sole purpose of identifying, marketing and branding Brothers XX₂₀ Inc. program services and organizational mission/charter.

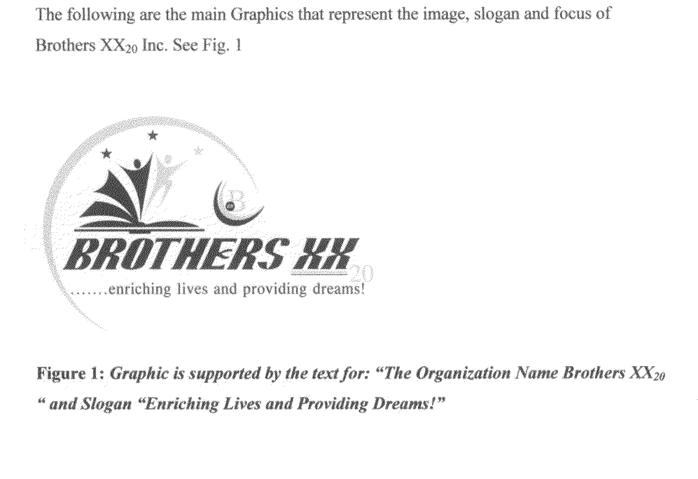

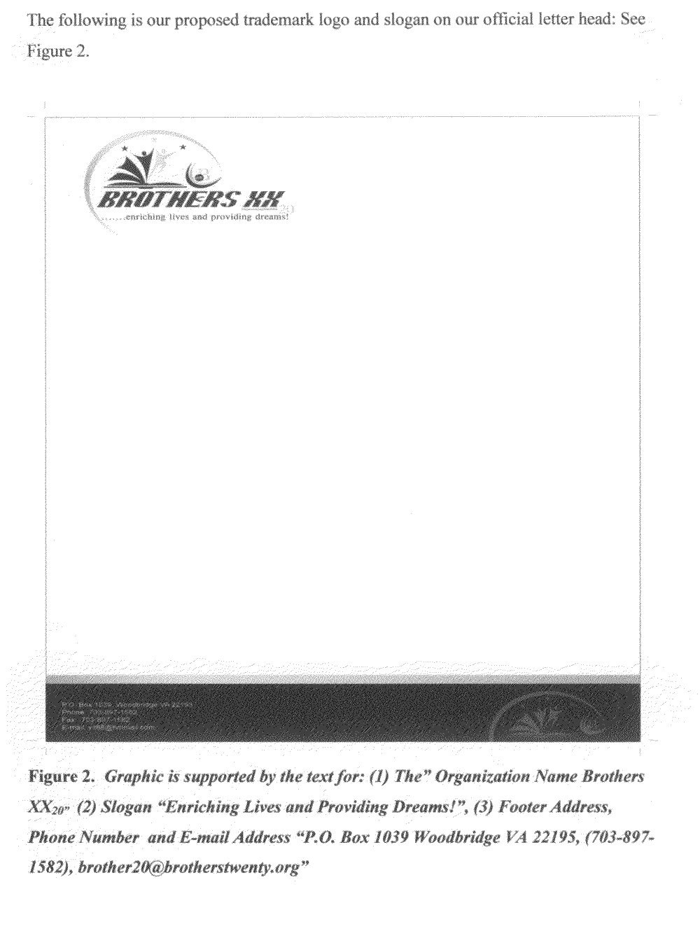

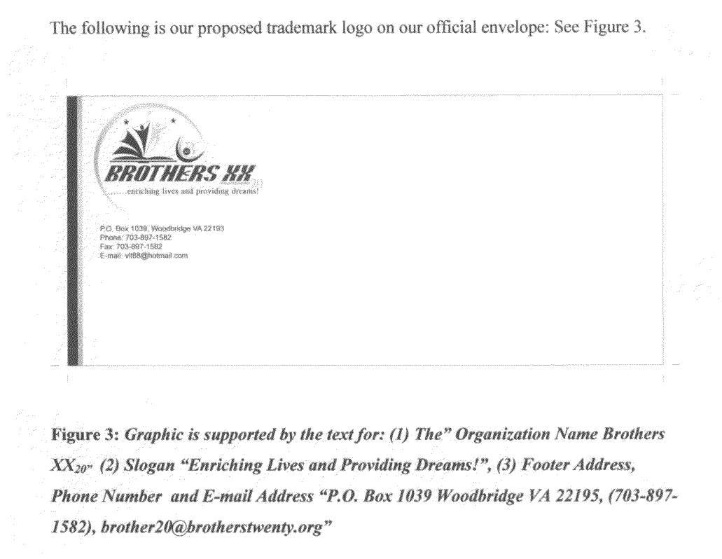

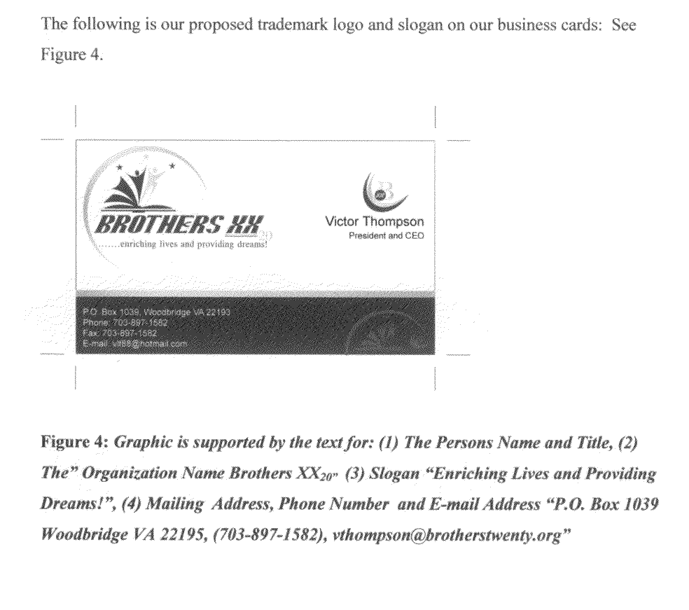

What is the significance of the organization's name “Brothers XX₂₀×?
“Brothers” represent the cooperative mission of all committed to the organization's mission.
The roman numerals “XX” represent the old guard of the friendship.
The subscripted “20” represents the new generation of committed individuals.

What is the meaning of the organization's trademark symbol?
The golden arc symbolizes the overarching support the organization provides aspiring, underprivileged and at-risk youth.
The open book symbolizes our commitment to academic endeavors as all of our programs and services infuse academics at the core of their foundation.
The two diverse figures stepping through the pages of a book represent the rainbow of children the organization serves.
The stars symbolize our desire to encourage a child to reach for the stars, by enriching lives and providing dreams.

Brothers XX₂₀ Inc. Name and Logo Description. This substitute specification includes no new matter.

The application is to trademark and protect the original name, images and graphics used to represent Brothers XX₂₀ Inc. by way of Logos, Business Cards and Stationary (Envelope and Letter Head).

1. This specification makes claim that the use of the included graphics and name are original and were developed by Victor Thompson. The core colors are Blue and Gold. The name is defined as Brothers XX₂₀. The XX is the Roman numeral representation of the number 20. The subscript 20 is to assist in the recognition of the XX roman numerals. The core colors are represented by digital codes (included as part of application)
